(19) United States
(12) Patent Application Publication
(10) Pub. No.: US 2025/0206528 A1
(43) Pub. Date: Jun. 26, 2025

(54) NESTED 3D STORAGE

(71) Applicant: Atwater26 Inc., Westmount (CA)

(72) Inventors: Frédérick REID, Westmount (CA); Shubham BACHARAM RAUT, Montréal (CA)

(21) Appl. No.: 19/003,057

(22) Filed: Dec. 27, 2024

Related U.S. Application Data
(63) Continuation of application No. PCT/CA2023/050890, filed on Jun. 28, 2023.
(60) Provisional application No. 63/356,101, filed on Jun. 28, 2022.

(51) Int. Cl. B65G 1/04; B65G 1/12; B65G 1/137; B65G 39/02

(52) U.S. Cl. CPC B65G 1/0478; B65G 1/12; B65G 1/1371; B65G 39/025

(57) ABSTRACT

Systems and methods for storing, organizing, and presenting parcels in a storage unit are provided. The storage unit may be subdivided into a number of cells, and the contents of each cell can be shuffled similar to a sliding box puzzle to store, organize or deliver a particular parcel to a desired location in the storage unit. The cells may be further subdivided into sub-cells, which themselves can be shuffled, allowing a user to maximize spacial efficiency by matching parcels to cells or sub-cells of similar sizes and/or shapes. The storage unit may be equipped with a processor to manage shuffling operations, permissions to access certain cells and/or sub-cells, and keep track of the contents of each cell and/or sub-cell.

This patent application is a continuation patent application of PCT/CA2023/050890 filed on Jun. 28, 2023, designating the United States, that claims priority to U.S. provisional patent application 63/356,101 filed Jun. 28, 2022, the contents of which are hereby incorporated by reference.

### TECHNICAL FIELD

This patent application relates to systems and methods for high density and automated storage, retrieval and resupply of objects within storage units.

### BACKGROUND

Storage units, such as warehouses, are needed to store a variety of deliverable products. More efficient storage would allow users to store a greater number of products in a smaller space, increasing their delivering capacity. There is a need for ever more efficient storage.

One way to increase storage efficiency is through automation. The use of robots in storage units to store and retrieve products reduces the space needed as robots are smaller in size than humans and thus storage units can be designed with smaller access points (such as corridors between rows of products) to store and retrieve products.

Recent inventions have allowed for further increases in storage efficiency. U.S. Pat. No. 10,246,255 B2 describes a high-density automated storage and retrieval system involving a 3D storage unit in a lattice structure, in which a number of uniformly sized containers may be stored and retrieved automatically. Due to the use of drivers and rails, the automated storage and retrieval machinery uses minimal space. Due to the configuration of the system, only one storage space within the structure need be empty for the system to store or retrieve any container (the system acts similarly to a “sliding block puzzle,” where each container represents a block within the puzzle). Software is used to calculate the steps needed to shuffle the containers in a desired fashion and operate the machinery to move the containers, and memory can store the position of the containers.

However, the prior art contains a significant limitation: to function in the 3D lattice structure and for delivery in the driver/rail system, all containers need to be the same size, the size of a unit accepted by the lattice structure. A number of issues are created by this limitation.

A first issue is that large items cannot be stored in the system if they are larger in size than the container, or even if they are smaller in overall size than the container but have one dimension that is larger than the dimensions of the container. This issue is especially important for companies delivering products of different sizes.

A second issue is that small items, while they can be stored, greatly decrease the spacial efficiency of the system as they must be stored in a container of a certain size, no matter how small the item. For example, if the container is around one cubic meter in volume, but the product is one cubic decimeter in volume, there is a waste of 999 cubic decimeters of space as the rest of the container is empty. This issue is especially important for companies delivering products of different sizes. This issue is not merely solved by filling the container with products until it is full, as some products may be irregularly shaped to prevent convenient placement with other products, or the warehouse may be publicly accessible by customers who are to retrieve only one product.

A third issue is that an automated storage and retrieval system that has uniformly sized containers has an exponentially increasing retrieval time as the size of the system increases.

A fourth issue is that an automated storage and retrieval system that has uniformly sized containers has an exponentially increasing resupply time as the size of the system increases.

### SUMMARY OF THE INVENTION

The present disclosure relates to systems and methods for improving high density automated storage and retrieval storage units that overcome the issues related to the one-size container system in the prior art.

Systems and methods for storing, organizing, and presenting parcels in a storage unit are provided. The storage unit may be subdivided into a number of cells, and the contents of each cell can be shuffled similar to a sliding box puzzle to store, organize or deliver a particular parcel to a desired location in the storage unit. The cells may be further subdivided into sub-cells, which themselves can be shuffled, allowing a user to maximize spacial efficiency by matching parcels to cells or sub-cells of similar sizes and/or shapes. The storage unit may be equipped with a processor to manage shuffling operations, permissions to access certain cells and/or sub-cells, and keep track of the contents of each cell and/or sub-cell.

A broad aspect of the present disclosure relates to a method for storing and retrieving objects within a storage unit using nesting to maximize spacial efficiency. The introduction of nesting allows for different parcels of different sizes to be stored and retrieved and overcomes the issues of storing large and small items, reduces retrieval time and allows for more convenient resupplying of the warehouse.

The present disclosure is further described in the detailed description. It should be clear to one skilled in the art of the multiple applications of the present disclosure, which cannot all be summarized in this application.

### BRIEF DESCRIPTION OF THE DRAWINGS

The system of the present disclosure will be better understood by way of the following detailed description of embodiments of the invention with reference to the appended drawings, in which:

FIG. 1 is a box diagram showing a storage unit with a lattice structure from the prior art.

FIG. 2 is a box diagram showing a storage unit with nesting capabilities whose cells have been subdivided into subcells.

FIG. 3 is a box diagram showing a storage unit with nesting capabilities whose cells have been subdivided into subcells of unusual dimensions storing some parcels.

FIG. 4 is a depthless view of the side of a storage unit with nesting capabilities using frames.

FIG. 5 is a depthless view of the bottom of a storage unit with nesting capabilities using frames.

FIG. 6 is an isometric three-dimensional view of a storage unit with nesting capabilities using frames.

FIG. 7 is a box diagram showing a storage unit with nesting capabilities using frames whose cells have been subdivided into subcells.

FIGS. 8A and 8B are two isometric three-dimensional views of a storage unit with nesting capabilities.

FIG. 9 is a box diagram exemplifying the shuffling steps involved in storage of a product within a storage unit with nesting capabilities.

FIG. 10 is a box diagram exemplifying the shuffling steps involved in retrieval of a product in a storage unit with nesting capabilities.

FIG. 11 is a box diagram exemplifying the shuffling steps involved in resupplying a storage unit with nesting capabilities.

FIG. 12 is a flowchart of steps to store and retrieve a product in a storage unit with nesting capabilities.

FIG. 13 is a flowchart of steps to resupply a storage unit with nesting capabilities.

### DETAILED DESCRIPTION

The present disclosure relates to systems and methods for increasing efficiency of storage units with high density and automated storage and retrieval, using nesting.

In the present disclosure, ‘nesting’ refers to the process of having cells act as a ‘nest’ containing multiple smaller subcells. In turn, those smaller subcells may also act as nests for even smaller subcells. Each cell or subcell may contain one or more parcels. The sizes of the cells, subcells or parcels may sometimes be referred to in this application as ‘levels’. For example, ‘large’ is a level higher than ‘medium’, which in turn is a level higher than ‘small’, which in turn is a level higher than ‘miniscule’.

As will be seen in the description of the figures, the process of storing small parcels within small subcells, which in turn may be stored within medium subcells, which in turn are stored within large cells, allows for a storage unit to store parcels of various sizes with minimal wasted space, overcoming the issues related to the size of parcels described in the background. The introduction of nesting may also expedite storage, retrieval and resupply within the unit.

The word ‘parcel’ is used to refer to any object of any size. The word ‘parcel’ is chosen because one of the intended embodiments of the invention is for the delivery of objects to consumers.

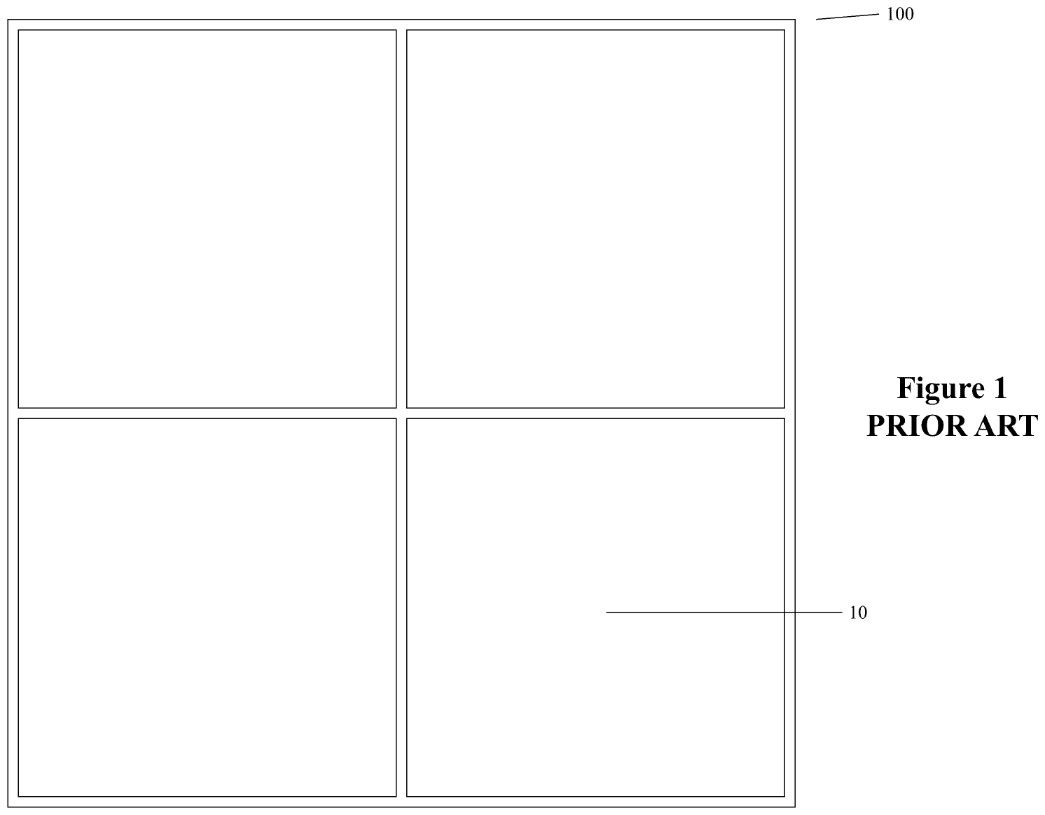

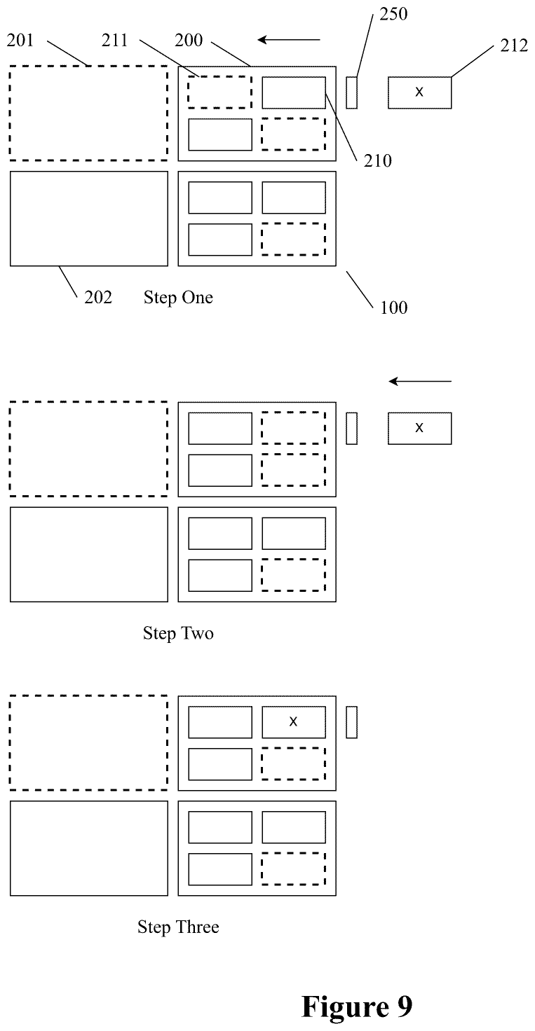

FIG. 1 is a box diagram showing a storage unit with a lattice structure from the prior art. In this embodiment, a storage unit 100 contains multiple cells 10 of the same size. At least one cell 10 should be empty at all times, allowing the cells 10 to be shuffled along x, y and z axes within the storage unit, similar to a three-dimensional sliding box puzzle manner. Storing an item larger than the size of the cell 10 is impossible and storing items of smaller size than the cell 10 wastes space. It should be understood that in some embodiments, as seen for example in FIG. 9, the system may require more than one empty cell to perform all necessary shuffling operations. One skilled in the art would appreciate that the systems described herein can be modified in various ways and thus may require one or more empty cells.

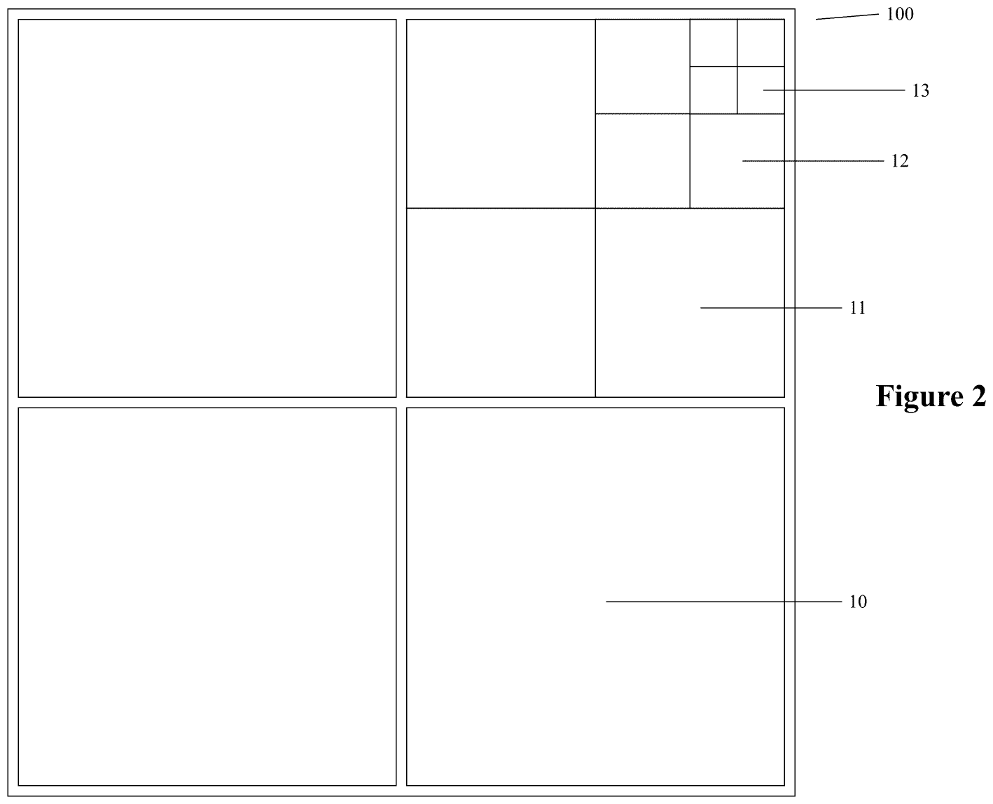

FIG. 2 is a box diagram showing a storage unit with nesting capabilities whose cells have been subdivided into subcells. In this embodiment, only one cell 10 of the storage unit 100 has been divided into subcells, however, in other embodiments more cells 10 may be divided into subcells. In this embodiment, a large cell 10 has been divided into four medium subcells 11, one of which has been divided into four small subcells 12, one of which has been divided into four miniscule subcells 13.

In the exemplary embodiment of FIG. 2, and also for the rest of the figures, no rails, drivers, coverings or other machinery for moving the cells or frames within the system are shown to reduce confusion in the drawing. Similarly, an input/output port, which acts as an interface between the inside and outside of the storage unit, is not shown for simplicity of the drawings.

FIG. 2 shows some of the advantages of the current invention. The introduction of nesting immediately overcomes the two first issues discussed in reference to the prior art. The issue of not being able to store larger parcels is overcome by having large cells that can be the size of one quarter or one eighth of the storge unit. The issue of inefficient storage of smaller items is overcome by having the possibility of medium, small or miniscule cells which can fit more of the smaller items. For example, while the storage unit 100 can hold three large parcels in the three large cells 10 (not four because one space must be left open for movement of the cells), each large cell 10 can also hold four medium subcells 11, sixteen small subcells, sixty four miniscule subcells, combination of large, medium, small and miniscule cells and subcells (e.g., a storage unit 100 with two large cells, one medium subcell and forty eight miniscule subcells). So, one storage unit with high density and automated storage and retrieval with nesting capabilities can hold large items (e.g., a bicycle) and multitudes of smaller items (e.g., a USB key) within the same storage unit with each item being stored in a cell sized to the size of the item.

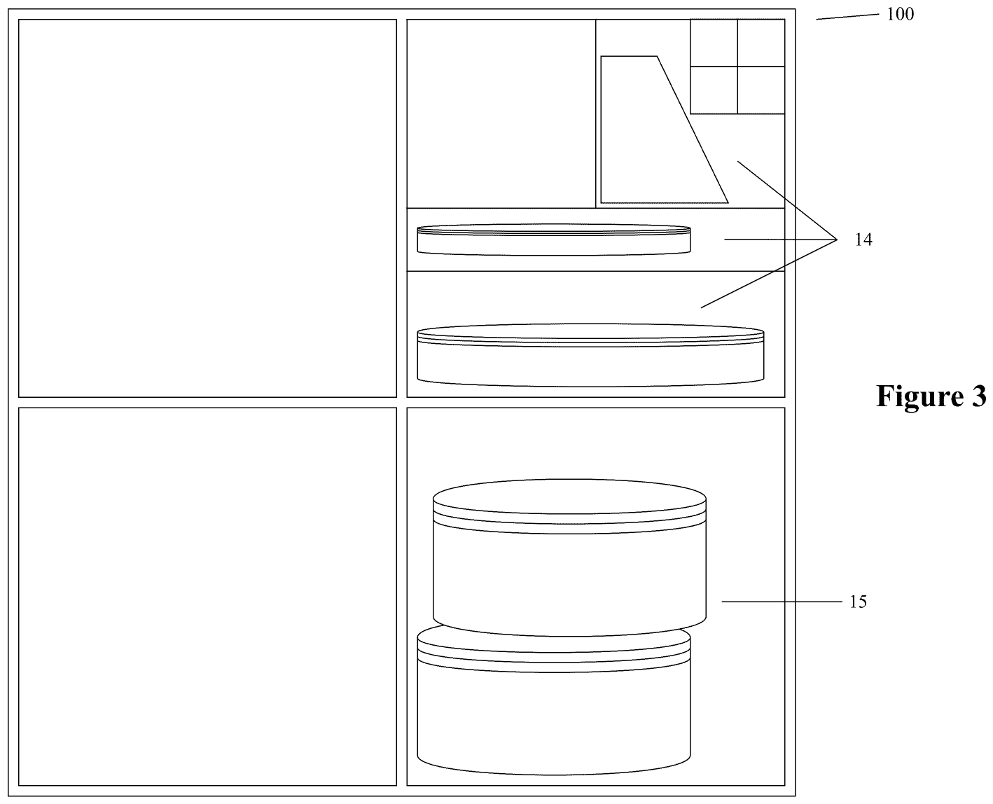

FIG. 3 is a box diagram showing a storage unit with nesting capabilities whose cells have been subdivided into subcells of unusual dimensions storing some parcels. Many parcels come in unusual dimensions (e.g., hockey sticks are long and thin). In this embodiment, the storage unit 100 has several cells, one of which has been divided into a number of unusually sized subcells 14 storing parcels of unusual sizes. In this embodiment, there is also a cell 15 storing more than one parcel. The ability to have unusually sized cells or subcells allows for the storage unit to easily handle unusually sized parcels with minimal loss of efficiency. Additionally, the storage of more than one parcel in one cell or subcell allows for the grouping of items with a similar destination or of a similar type. For example, if the two parcels of cell 15 are destined to be delivered to one individual, it saves time and effort to store the parcels together.

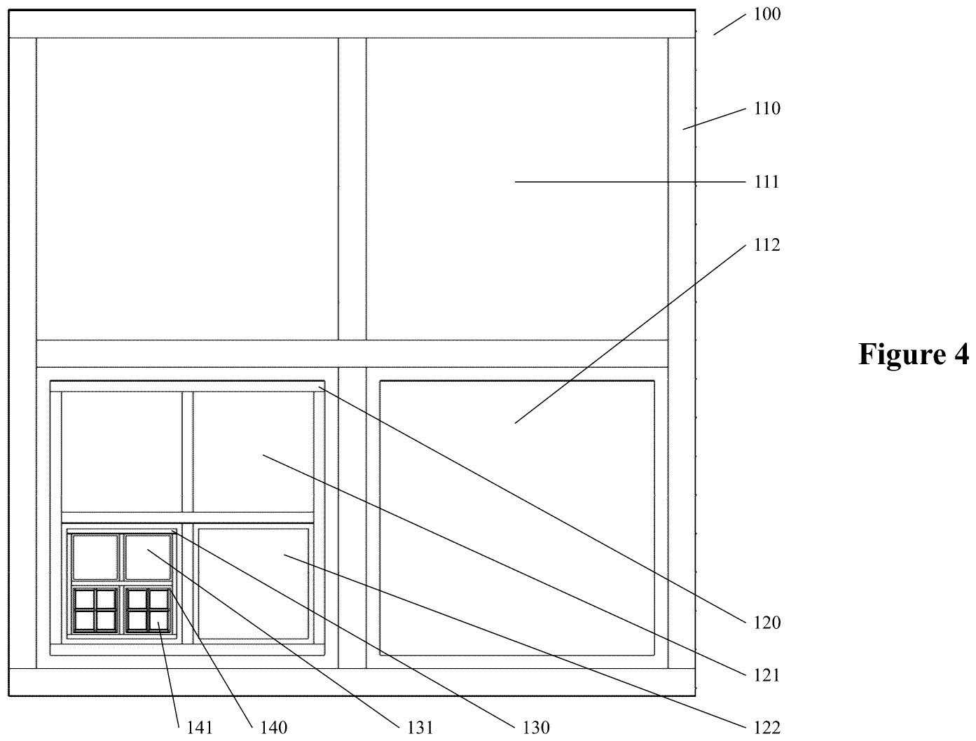

FIG. 4 is a depthless view of the side of a storage unit with nesting capabilities using frames. A frame is a lattice structure of uniformly sized empty spaces called cells in which parcels can be placed. In the exemplary embodiment, the storage unit 100 includes a large frame 110 (which can be thought of as the storage unit itself) subdivided into large cells 111. One large cell 111 is holding a large parcel 112, another large cell 111 is holding a medium frame 120. The medium frame 120 in turn is subdivided into medium cells 121. One medium cell 121 is holding a medium parcel 122, another medium cell 121 is holding a small frame 130. The small frame 130 in turn is subdivided into small cells (not indicated for simplicity). Two small cells are holding small parcels 131 and two small cells are holding miniscule frames 140. The miniscule frames 140 each in turn are subdivided into miniscule cells (not indicated for simplicity). The miniscule cells are holding miniscule parcels 141. Only four of the eight cells or subcells of any level are visible due to the depthless nature of the Figure, the others are behind the four visible ones.

In some embodiments, there may be different number of cells or subcells in each row, column, lattice or frame in the embodiments discussed herein. For example, although FIG. 4 shows a 2×2 arrangement, there may instead be a 3×3 arrangement of cells, or 2×4 arrangement, etc. The cells themselves may be of various shapes and sizes, as is needed for the desired application or as is required by the arrangement of cells.

In some embodiments, there may be different number of cells or subcells in each row, column, lattice or frame between levels. For example, the large cells may have a 2×2 arrangement, however, the medium cells may have a 3×3 arrangement, and the small cells may have a 4×4 arrangement. In another example, the large cells may have a 2×2 arrangement while medium cells have a 2×1. In another example, the large cells may have a 2×3 arrangement while medium cells have an irregular arrangement, for example with an L shaped medium cell and a square medium cell within a medium frame. The possibilities are endless. The system (and any of its components, such as cells, frames, bins, etc.) is able to be configured to match any desired function, for example, cells that are long and narrow may be required to dispense water boards at a beach. In other cases, the cells may be suitable for distribution of mail or the like.

In the exemplary embodiment, each large cell and medium frame have dimensions of around 2×2×4 meters. In some embodiments, the exact dimensions of the storage unit or any subcomponents of it (frames or cells) may change. For example, the frames and cells may have a cubic shape instead of a rectangular one. For example, the dimensions of the storage unit may be adjusted such that the storage unit is the size of a standard shipping container. For example, the dimensions of the cells and frames may be adjusted such that each level can contain sixteen cells of that level or frames of a smaller level instead of eight (e.g., a medium frame may contain sixteen medium cells).

In some embodiments, there may be more or fewer parcels or frames of various sizes than shown in FIG. 4. For example, a storage unit similar to the one shown in FIG. 4 may have a second large parcel above the one currently represented in FIG. 4 (large parcel 112). For example, a storage unit 100 delivering only large products may not need medium, small or miniscule frames, and thus only contain large cells with large parcels 112.

In some embodiments, the cells may be outfitted with features to improve the capacity of quality of the storage of parcels. For example, a cell may be outfitted with a box in which parcels can be stored, which may facilitate shuffling or ensure that the parcel isn't lost within the storage unit outside of the cells. For example, a cell may contain padding or similar layer to reduce collisions between the parcel and the cell, or frame or storage unit in which the cell is stored.

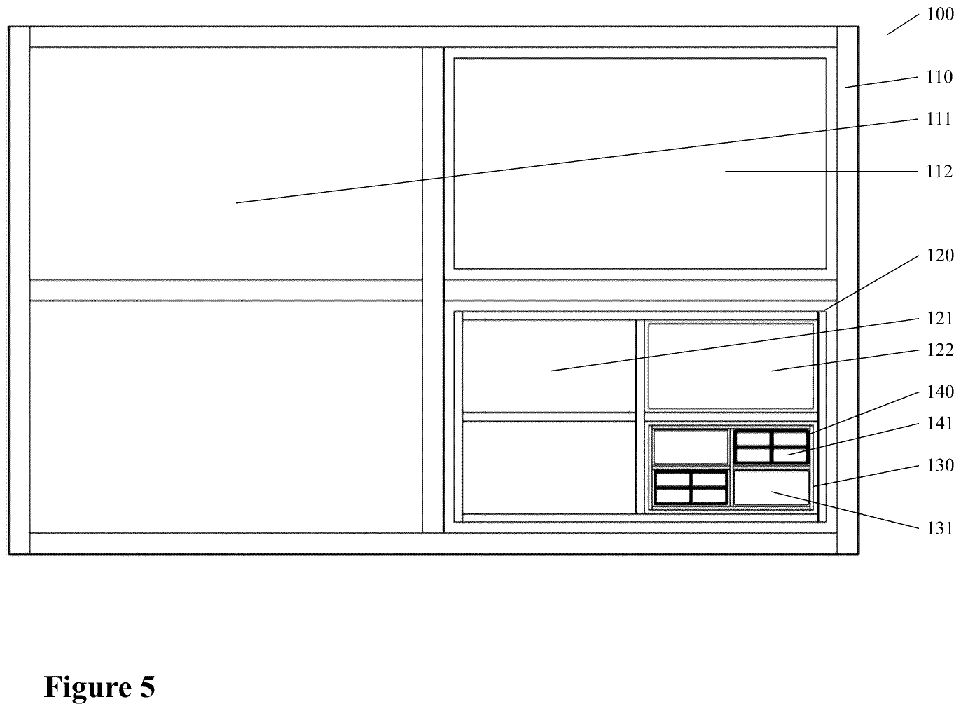

FIG. 5 is a depthless view of the bottom of a storage unit with nesting capabilities using frames. FIG. 5 describes the same exemplary embodiment as FIG. 4, merely from a different view, and thus contains the same specifications and possible variations as the embodiments described in view of FIG. 4.

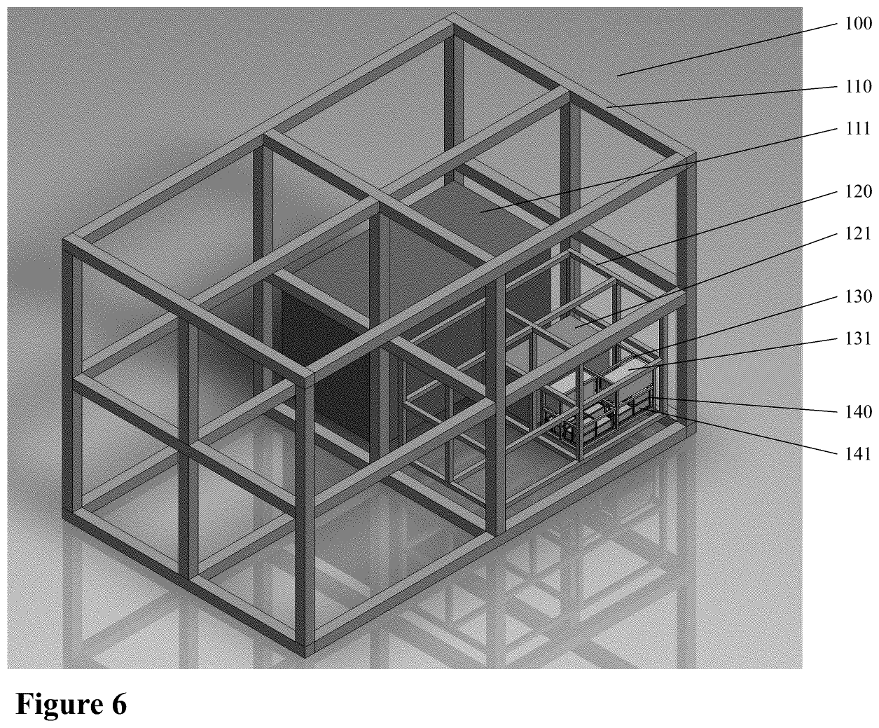

FIG. 6 is an isometric three-dimensional view of a storage unit with nesting capabilities using frames. FIG. 6 describes the same exemplary embodiment as FIG. 4, merely from a different view, and thus contains the same specifications and possible variations as the embodiments described in view of FIG. 4.

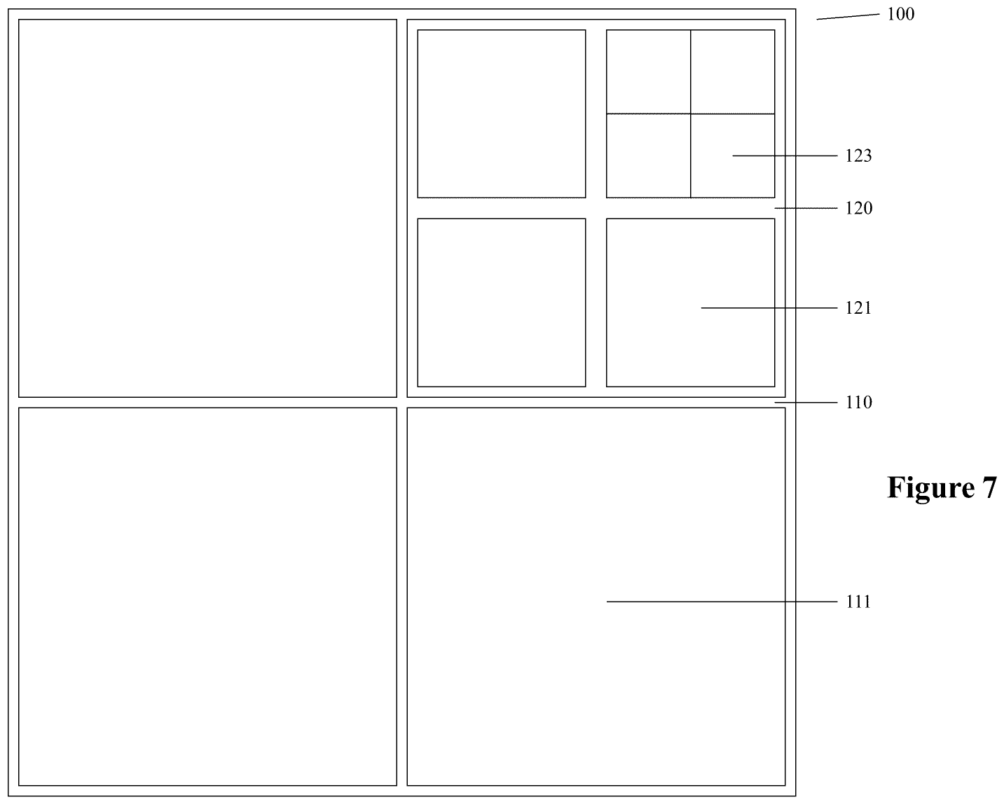

FIG. 7 is a box diagram showing a storage unit with nesting capabilities using frames whose cells have been subdivided into subcells. In the exemplary embodiment, a storage unit 100 is subdivided into large cells 111, one of which contains a medium frame 120, itself subdivided into medium cells 121, one of which is subdivided into medium subcells 123. As such, frames and the cells within frames can be divided as many times as is desired into subcells. The dimensions of the subcells may also be unusual, as with FIG. 3.

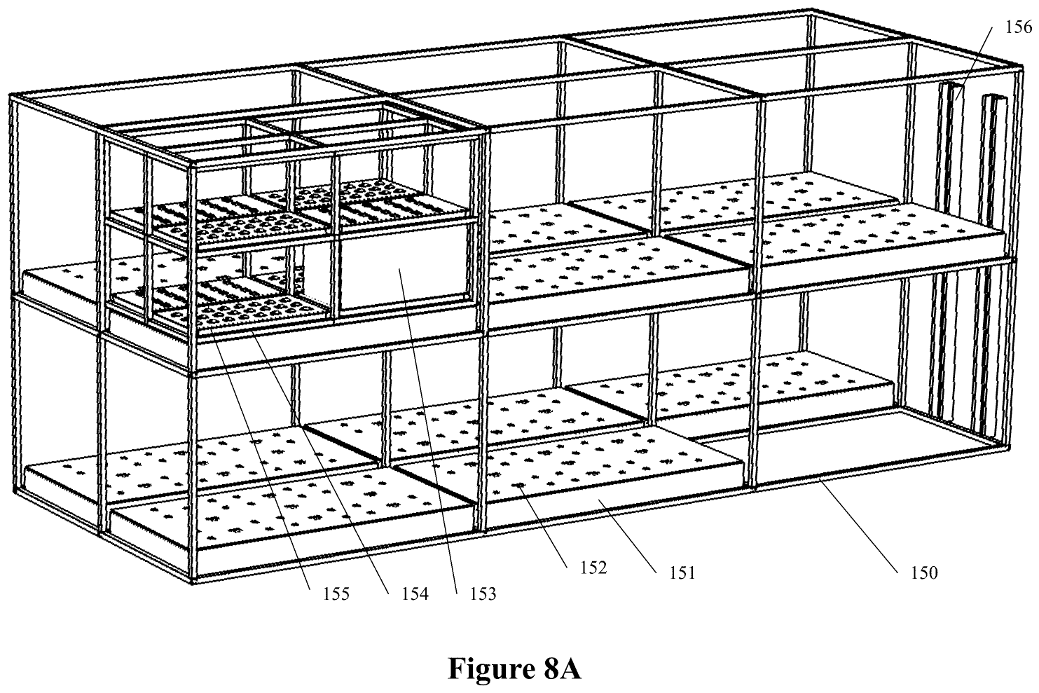

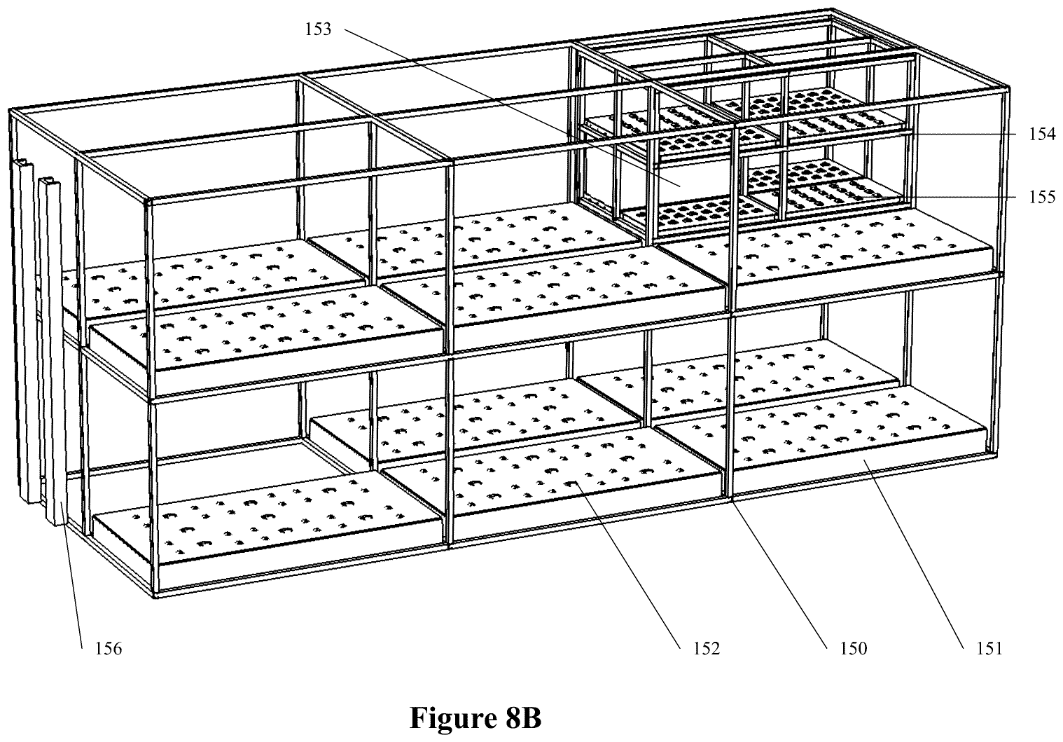

In some embodiments, the storage units may be outfitted with additional machinery to facilitate organization, customizability, production constraints or specific customer needs. FIGS. 8A and 8B show one embodiment with such additional machinery.

FIGS. 8A and 8B are two isometric three-dimensional views of a storage unit with nesting capabilities. In the exemplified embodiment, a large frame 150 contains a 2×3×2 arrangement of large cells, most of which are outfitted with a large platform 151. The only large cell in the exemplified embodiment without a large platform 151 is the large cell on the first level next to the rails 156. This will be explained further below. The various platforms (both large 151 and medium 155) are outfitted in the exemplified embodiment with omni wheels 152 that allow for parcels or bins/containers holding the parcels to be moved on the platforms (and it should be noted that platforms of any shape or size can be outfitted with omni wheels). The large platforms 151 may also hold medium frames 154, which themselves hold medium cells outfitted with medium platforms 155 which can hold medium parcels or bins holding parcels. In the exemplified embodiment, a medium bin 153 is being held. The medium bin may be pushed from medium platform to medium platform until the desired location in the medium platform is reached. The medium bin may also be pushed onto a neighbouring large platform. The omni wheels, in this embodiment, give the user the ability to move items within the storage unit as desired. The storage unit is outfitted with rails 156 for moving large platforms between the bottom level and top level of the exemplified storage unit. In embodiments where the platforms are not configured to move, such as the one exemplified in FIGS. 8A and 8B, only the large platform adjacent to the rails can be moved from a top row to a bottom row. The combination of platforms with omni wheels, which allow parcels to be moved to platforms at a similar elevation, with rails, which can move parcels to different elevations, allows any parcel to reach any cell.

In some embodiments, such as the one exemplified in FIGS. 8A and 8B, there may be required to have more than one empty space to accomplish the shuffling required to move parcels throughout the storage unit as desired. In the exemplified embodiment, it is clear that, in order for the rails to move the adjacent large platform from row to row, the destination space (here, the bottom space) must not already be filled with a platform. It must be empty. Thus, for a parcel to be shuffled from the top rows of the system of FIGS. 8A and 8B to a desired location in the bottom rows, there must not only be an empty space for shuffling on the top rows, but there must also be an empty space for shuffling on the bottom rows for when the rails move the parcel down to the bottom rows. Thus, in an embodiment using rails, there may be required to have additional empty spaces, here, two empty spaces, to allow for full range of shuffling parcels in any location in the storage unit. In some embodiments with different numbers of rows or rails, or using different movement machinery, there may be required more or fewer empty spaces to allow for shuffling.

In some embodiments, there may be no platforms, omni wheels or rails. In some embodiments, the platforms, omni wheels or rails may be replaced by machinery that may accomplish a similar function. In some embodiments, there may be more or fewer platforms, omni wheels or rails. For example, especially for embodiments with more rows, or large storage units expecting to handle multiple shuffling requests at once, it may be convenient to have more than one set of rails to allow for simultaneous or parallel movement of multiple parcels. In some embodiments, the platforms, omni wheels or rails may be shaped differently, for example, the platforms may be shaped to fit irregularly shaped cells.

One important aspect of the rail in the exemplified embodiment is that it may be able to not only move parcels or bins containing parcels between the rows of large cells, but may also be able to move at incremental, intermediary levels to raise or lower the adjacent large platform to the level of a medium, small or miniscule cell or platform, or any number or shape or irregularly shaped platforms. This is important because, at least in the exemplified embodiment, parcels cannot be moved via the omni wheels between different levels of cells, due to the presence of platforms—i.e., a parcel cannot move from a large platform onto the medium platform—they are not on the same elevation (since the medium platform has a certain thickness). However, if the parcel moves on to the large platform adjacent to the rails, the rails can move the large platform up the necessary height to bring the large platform flush with the elevation of the medium platform, so that the parcel can be placed on the medium platform. This may function the same for removing parcels from certain cells or presenting certain parcels to an input/output port.

In some embodiments, the storage unit may have additional machinery integrated with the frames, platforms or bins for containing parcels. For example, if the storage unit is designed for dispensing electric scooters to users who will rent them for commute, the platforms may be outfitted with charging devices so that the scooters can be recharged when they are returned to the storage unit.

In some embodiments, the presence of the omni wheels may permit not only for movement along x and y axes of a platform, but may also allow for the rotation of a parcel or bin containing a parcel. This may be especially useful for situations where the storage unit contains items that should be accessed from different sides. For example, if the storage unit holds squares that are subdivided into many compartments, such as a communal mailbox is a metal square subdivided into many individual compartments, the storage unit may wish to be able to rotate the square to allow a user to access compartments on the back of the square. This may be useful if a storage unit is configured to store a set of lockers (such as a communal mailbox, or bank safety deposit boxes).

FIG. 9 is a box diagram exemplifying the shuffling steps involved in storage of a product within a storage unit with nesting capabilities. In the exemplary embodiment, a parcel to be stored 212 is sitting just outside the input/output port 250 of the storage unit 100 containing a large cell with a large parcel 202, medium frames 200, a large empty cell 201 and medium empty cells 211. For simplicity, many parts of the storage unit 100 are omitted, such as the presence of machinery moving the cells, the walls of the storage unit, or a covering of the storage unit. Additionally, the drawing is represented in 2D as opposed to 3D. The parcel to be stored 212 must be moved inside the storage unit 100. However, the presence of a medium cell containing a medium parcel 210 is blocking the way, so the storage unit 100 must shuffle the cells around until a medium empty cell 211 is adjacent to the input/output port 250. In step one, the top right medium cell containing a medium parcel 210 of the top right medium frame 200 is moved leftward, liberating a medium empty cell 211. In step two, the parcel to be stored 212 enters the storage unit 100 via the input/output port 250 and is placed into the medium empty cell adjacent to the input/output port 250. Step three shows the resulting storage unit 100.

In some embodiments, the storage unit may further shuffle cells that it contains, even after the storage procedure is complete.

In some embodiments, an input/output port 250 may be configured to store different levels of cells, such as large cells with large parcels.

In some embodiments, cells may store multiple parcels grouped together at the same time. For example, if a user is storing three parcels of a small size, the three parcels may be grouped together inside a medium cell which, when presented at an input/output port, allow the user to store all their parcels at once.

Although the steps in storage in FIG. 9 were simple, it is possible that some scenarios may involve a greater number of shuffling steps for storage. In these scenarios, some of the shuffling steps may be accomplished in parallel (e.g., moving a small cell within a medium frame while another medium frame is moving).

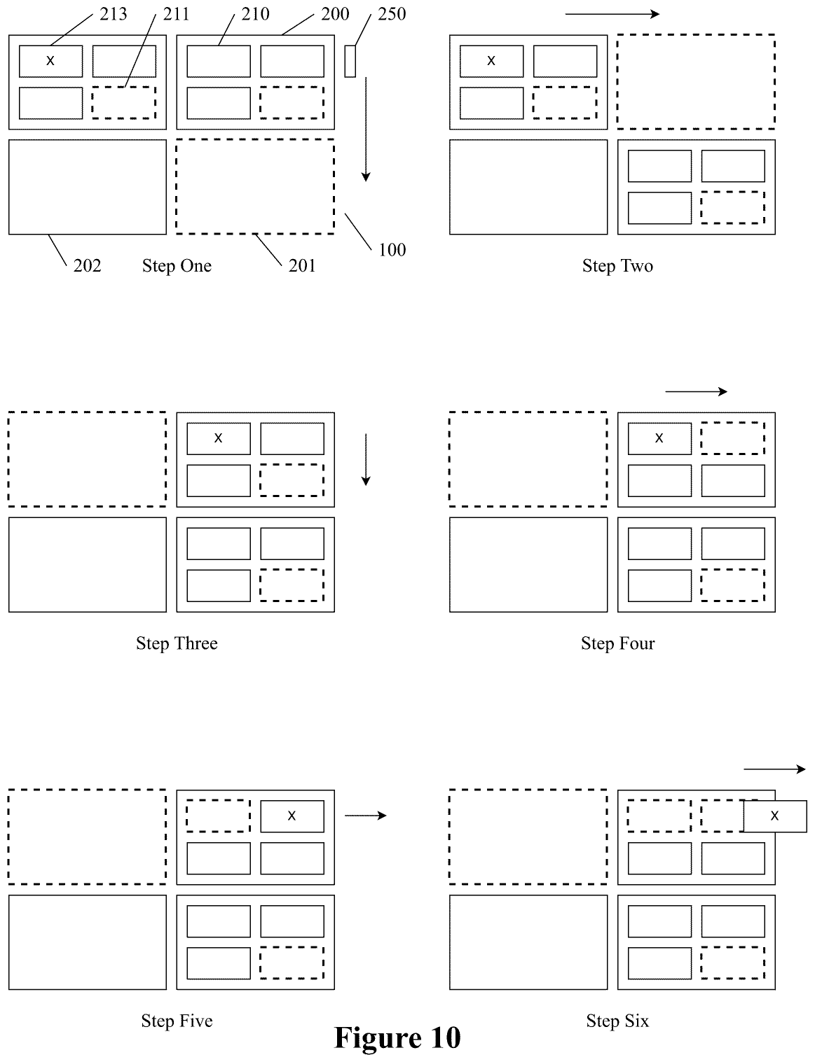

FIG. 10 is a box diagram exemplifying the shuffling steps involved in retrieval of a product in a storage unit with nesting capabilities. In the exemplary embodiment, a cell containing a desired parcel 213 (also labelled with an X) must be moved to an input/output port 250. The cell containing a desired parcel 213 is on the opposite side from the input/output port 250, and so the storage unit 100 must shuffle the cells around into the empty spaces until the cell containing a desired parcel 213 reaches the input/output port 250. In the exemplary embodiment, there are two levels present: two medium frames 200, one large empty cell 201 and one large cell containing a large parcel 202, many medium cells containing medium parcels 210 and some medium empty cells 211. For simplicity, many parts of the storage unit 100 are omitted, such as the presence of machinery moving the cells, the walls of the storage unit, or a covering of the storage unit. Additionally, the drawing is represented in 2D as opposed to 3D, and the input/output port 250 is not represented in every figure, however a reader may imagine it always present at the top right side of the drawing as it is in step one. In step one, the top right medium frame is moved downward. In step two, the top left medium frame is moved rightward. In step three, the top right medium cell of the top right medium frame is moved downward. In step four, the top left medium cell of the top right medium frame is moved rightward. In steps five and six, the cell containing a desired parcel 213 is moved outside of the storage unit through the input/output port 250.

In some embodiments, some of the steps described in FIG. 10 may be performed in parallel. For example, steps one and three may be performed in parallel. Steps two and four may also be performed in parallel. Performing the steps in parallel may also contribute to increasing the speed of retrieval.

In some embodiments, an input/output port 250 may be configured to receive different levels of parcels, such as a large parcel.

In some embodiments, the nesting feature may also be used to deliver multiple parcels grouped together at the same time. For example, if a customer is retrieving a delivery from the storage unit and has ordered three parcels of a small size, the three parcels may be grouped together inside a medium cell which, when presented at an input/output port, allow the customer to retrieve all their parcels at once.

FIGS. 9 and 9 illustrate how nesting overcomes difficulties associated with storage and retrieval time that are present in the prior art. With nesting, the number of shuffling steps to achieve a desired configuration of cells, such as for storage or retrieval, is reduced especially as the size of the storage unit increases. This is because one step of shuffling of a frame of a higher level (such as the movement of the top right medium frame in step one of FIG. 10) is equivalent to many steps of shuffling in a cell of lower level. If, for example, in FIG. 10, the top right medium frame of step one didn't exist, and in its place were just three medium cells, the storage unit would need to calculate and execute at least two steps of shuffling to move the two columns of medium cells downward (and out of the way of the top left medium frame of step one). As the size of the storage unit increases, the number of steps required to move a cell to a desired location increases linearly with nesting, but exponentially without nesting (assuming one action is performed at a time).

Although FIGS. 8 and 9 show examples of storage units outfitted with frames, the same principles of storing and retrieving parcels by putting them through input/output ports and shuffling the cells apply to storage units outfitted with subdivided cells, such as the ones seen in FIGS. 2 and 3. The reduction of storage and retrieval time also applies to storage units outfitted with subdivided cells.

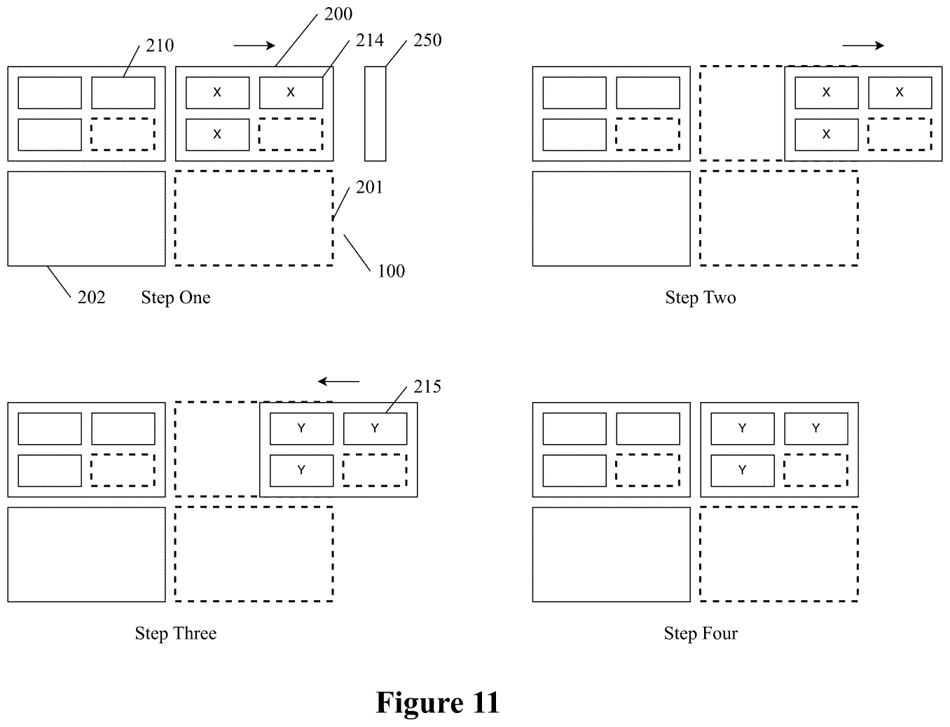

FIG. 11 is a box diagram exemplifying the shuffling steps involved in resupplying a storage unit with nesting capabilities. In the exemplary embodiment, the storage unit 100 contains one input/output port 250, one large empty cell 201, one large cell containing a large parcel 202, and two medium frames 200, one of which containing three empty medium cells 214 (also marked with an X). The empty cells 214 are due for resupply, so that the storage unit 100 can be resupplied to contain more products. For simplicity, the empty cells 214 are already adjacent to the input/output port 250, however, in other embodiments some shuffling may be needed to bring the empty cells 214 close to the input/output port 250. For simplicity, many parts of the storage unit 100 are omitted, such as the presence of machinery moving the cells, the walls of the storage unit, or a covering of the storage unit. Additionally, the drawing is represented in 2D as opposed to 3D, and the output port 250 is not represented in every figure, however a reader may imagine it always present at the top right side of the drawing as it is in step one. In steps one and two, the medium frame 200, containing the empty medium cells 214, is moved through the output port. In steps three and four, a medium frame containing three full medium cells 215 (also marked with a Y) is added to the storage unit.

FIG. 11 illustrates how nesting overcomes difficulties associated with resupply time that are present in the prior art. With nesting, the number of steps to achieve many changes in configuration (or shuffling of cells) such as for resupply is reduced, especially as the size of the storage unit increases. This is because a large portion of the storage unit, containing many subcells and therefore many possible locations for parcels, can be removed or added as one piece. Instead of resupplying forty-nine small cells individually, a user need only resupply one medium frame containing seven small frames each containing seven small cells. In storage units without nesting, each cell (no matter how big or small) would need to be retrieved and resupplied individually, and this would greatly increase the time and effort needed to resupply the storage unit. The more levels of nesting there are in a storage unit, the more cells can be changed at a single step.

In some embodiments, the storage unit may be configured to automatically nest empty cells together when the storage unit is idle. This would allow for the resupply operation to be even faster. For example, if a storage unit contained forty-nine empty small cells in different frames or compartments, the storage unit may recognize that the small cells are empty, shuffle them into small frames and shuffle those small frames into one medium frame so that all the empty cells are together. To resupply the unit, a user would only need to change out that one medium frame in a single, easy step.

Although FIG. 11 is exemplifying resupply in a storage unit with frames, the same concepts of resupply and increasing resupply efficiency can be applied to a storage unit with nesting without frames, such as the one seen in FIG. 2. Removing one cell empty cell and replacing it with a cell that has multiple subcells containing parcels allows for the resupply of multiple parcels in one action.

It should be understood that FIGS. 9-11 are there to illustrate the capabilities of the system and are not limiting. For example, in some embodiments, there may be required lifting or lowering platform operations performed by the rails 156 or movement of bins or parcels on omni wheels 152 to achieve the presenting, storing or sorting shown in FIGS. 9-11.

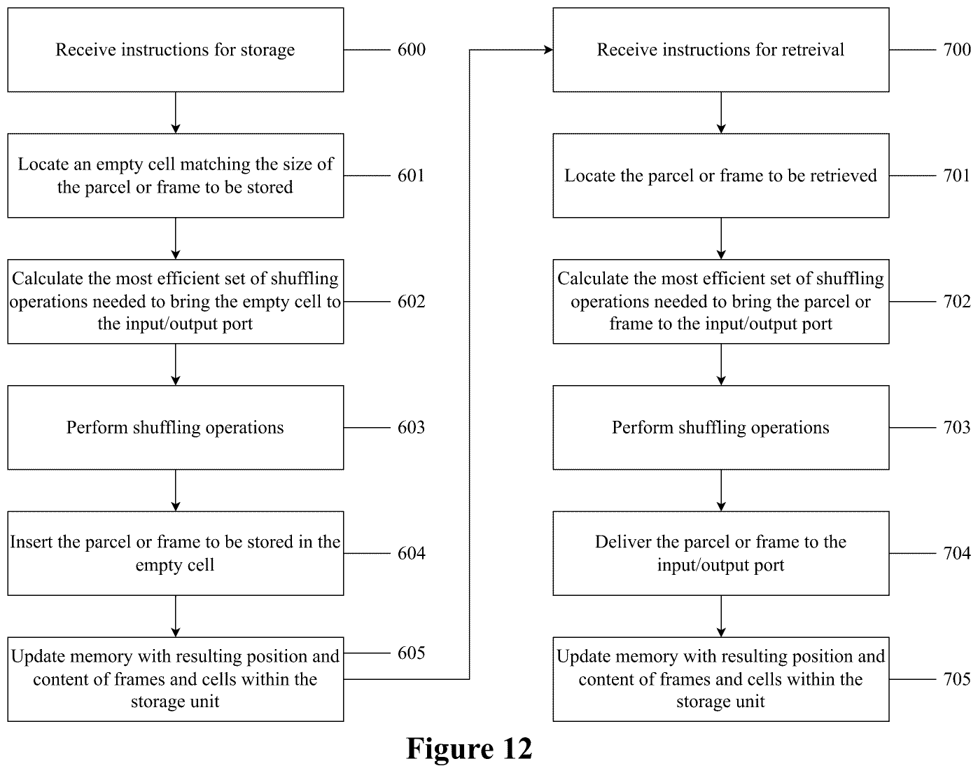

FIG. 12 is a flowchart of steps to store and retrieve a product in a storage unit with nesting capabilities. In the exemplary embodiment, the storage unit may receive instructions for storage 600 from a user. The storage unit may then locate an empty cell (or cell within a frame, or subcell) matching the size of the parcel or frame to be stored 601. The storage unit may then calculate the most efficient set of shuffling operations needed to bring the empty cell to the input/output port 602 so as to minimize the time and power consumption involved in shuffling. The unit may then perform the shuffling operations 603 determined in step 602. The storage unit may then receive the parcel or frame to be stored from the input/output port and insert it in the empty cell 604. The storage unit may update its memory with the resulting position and content of all frames and cells within the storage unit 605. The storage unit may receive instructions at a later time for retrieval 700 from a user. The storage unit may then locate the parcel or frame to be retrieved 701. The storage unit may then calculate the most efficient set of shuffling operations needed to bring the parcel or frame to be retrieved to the input/output port 702 so as to minimize the time and power consumption involved in shuffling. The storage unit may then perform the shuffling operations 703 determined in step 702. The storage unit may then deliver the parcel or frame to the input/output port and bring it outside the storage unit via the input/output port 704. Finally, the storage unit may update its memory with the resulting position and content of all frames and cells within the storage unit 705.

In some embodiments, locating an empty cell matching the size of the cell or frame to be stored may involve returning an error to the user if there is no more room in the storage unit.

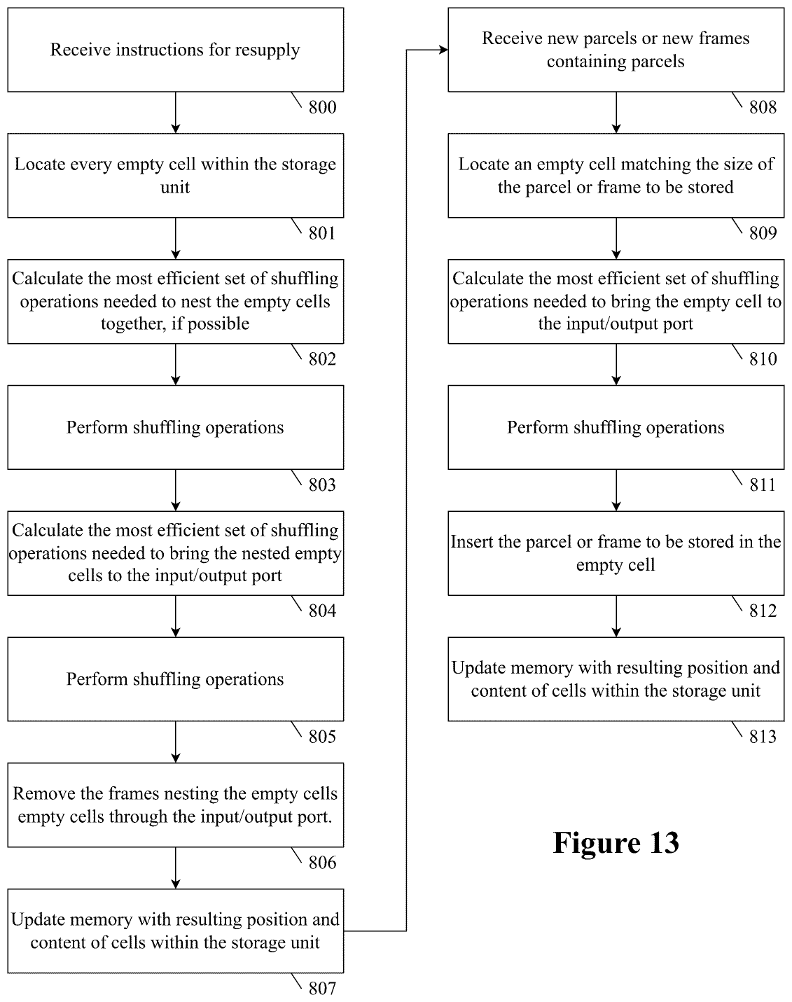

FIG. 13 is a flowchart of steps to resupply a storage unit with nesting capabilities. In the exemplary embodiment, the storage unit may receive instructions for resupply 800 from a user. The storage unit may then locate empty cells or frames within the storage unit 801. The storage unit may then calculate the most efficient set of shuffling operations needed to nest the empty cells or frames together 802 so as to minimize the time and power consumption involved in shuffling. For example, all empty small cells may be grouped together in one small frame, allowing multiple cells to be resupplied in one operation by changing the frame. The storage unit may then perform the shuffling operations 803 determined in step 802. The storage unit may then calculate the most efficient set of shuffling operations needed to bring the nested empty cells or frames to the input/output port 804 so as to minimize the time and power consumption involved in shuffling. The unit may then perform the shuffling operations 805 determined in step 804. The storage unit may then remove the frames nesting the empty cells through input/output port 806, creating space within the storage unit (note: it is of course possible for the cell to be a large cell designed to store a large product, and thus not contain a frame. In this case, the large cell need only be brought adjacent to the input/output port). The storage unit may update its memory with the resulting position and content of all frames and cells within the storage unit 807. The storage unit may then receive new parcels or new frames containing cells with parcels to resupply the storage unit 808. The storage unit may then locate an empty cell matching the size of the parcel or frame to be stored 809. Sometimes, an empty cell matching the size of the parcel or frame to be stored may already be adjacent to the input/output port, especially after steps 800-807. If an empty cell matching the size of the parcel or frame to be stored isn't already adjacent to the input/output port, the storage unit may then calculate the most efficient set of shuffling operations needed to bring the empty cell to the input/output port 810. The storage unit may then perform the shuffling operations 811 determined in step 810. The storage unit may then receive the parcel or frame to be stored from the input/output port and insert it in the empty cell 812. Finally, the storage unit may update its memory with the resulting position and content of all frames and cells within the storage unit 813.

In some embodiments, the steps 802 and 803 may not be required. However, in some embodiments, the ability of the storage unit to group empty cells or frames together greatly increases the storage unit's efficiency for resupplying compared to the prior art. For example, if a storage unit contains three hundred and forty-three small cells, ninety-eight of which are empty, the step of nesting all empty small cells together under two medium frames will allow for a user to resupply the storage unit only by removing two medium frames full of empty small cells (and then adding two medium frames with small cells containing parcels) as opposed to adding parcels to one empty small cell at a time.

It is possible that the concept of nesting may play an important part not only in the method of storing with high efficiency, but also in the development of algorithms for managing non-nested storage units.

There are any possible applications for the disclosed invention. For example, an automated storage unit may act as a public warehouse where customers can retrieve products they have ordered. For example, an automated storage unit may act as a housing unit for lockers, where each customer has purchased a cell of a certain size that is for their use only, and where the cells are secured so that only the customer can access them. In such an example, the storage unit would receive instructions to present certain lockers at certain times and would grant access to the locker via the input/output port of the storage unit. In another example, it may act as a deposit location where customers can deposit objects to return. For example, it can act as a temporary storage location for a company between deliveries, or a number of other applications.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

1. A method for distributing parcels, comprising:
a. providing a storage unit having one or more input/output ports and being divided into a lattice structure of uniformly sized cells, said lattice structure having at least one empty cell so that rows and columns of cells can be shuffled, using movement machinery, in a sliding box puzzle manner, to position a desired one of said cells to or away from said one or more input/output ports;
b. providing within at least one of said cells a structure having a plurality of subcells;
c. loading parcels into at least some of said cells and some of said subcells;
d. receiving a request to retrieve one of said parcels;
e. when said one parcel is stored within one of said cells, shuffling the cells of the storage unit to move said one or more requested parcels to be proximate to said one or more input/output ports of the storage unit, keeping track of the locations of the cells of the storage unit throughout said shuffling, and when said one parcel is stored within one of said subcells, shuffling the cells of the storage unit to move said cell containing said plurality of subcells containing said one parcel and positioning said subcell containing said one parcel to be proximate to said one or more input/output ports of the storage unit; and
f. providing access to said one or more requested parcels for retrieval of said one or more requested parcels via said one or more input/output ports.

2. The method of claim 1, wherein said loading parcels involves inserting them into the cells of the storage unit via the one or more input-output ports.

3. The method of claim 2, wherein said loading parcels further involves shuffling the cells of the storage unit each time a parcel has been inserted into a cell of the storage unit via the one or more input/output ports to bring an empty cell for the next parcel to be loaded.

4. The method of claim 1, wherein said loading parcels involves loading two or more parcels into said cells or said subcells outside said structure and loading said cells or said subcells containing said two or more parcels into said structure.

5. The method of claim 1, further comprising subdividing at least one subcells at least one additional time to create subdivided subcells of various dimensions which may hold smaller parcels of various dimensions.

6. The method of claim 1, wherein providing within at least one of said cells a structure having a plurality of subcells involves dividing the space within the cell into one or more walled subcells that are compartments of the cell.

7. The method of claim 1, wherein at least one of said cells contains a frame, a subcell lattice structure of uniformly sized subcells in which parcels can be placed.

8. The method of claim 7, wherein said subcell lattice structure has at least one empty cell so that rows and columns of subcells within the lattice structure can be shuffled, using movement machinery, in a sliding box puzzle manner to position a desired one of said cells to a desired location inside or out of the lattice structure.

9. The method of claim 7, wherein a cell of the frame holds at least one smaller frame with similar properties as the frame but is smaller in size.

10. The method of claim 8, wherein a cell of the smaller frame holds at least one miniscule frame with similar properties as the frame but is even smaller in size.

11. The method of claim 7, wherein said subcell lattice structure uses an adjacent empty one of said cells to receive one or more of said subcells to perform shuffling of said subcells.

12. The method of claim 6, wherein parcels of various dimensions are stored within the cells and subcells of various sized frames.

13. The method of claim 6, wherein at least one cell of said frames, smaller frames and miniscule frames have been subdivided to contain at least two walled subcells of various dimensions that are compartments of the cell in which parcels of various dimensions can be placed.

14. The method of claim 1, further comprising securing the cells or subcells.

15. The method of claim 13, wherein the secured cells or subcells are lockers.

16. The method of claim 1, wherein padding within the cells or subcells is provided to prevent damage to objects during movement of objects within the cells or subcells.

17. The method of claim 1, wherein said movement machinery comprises a base platform in one of said cells of said lattice structure, said base platform having two sets of motorized omni wheels for moving a container in two directions in and out of said one of said cells.

18. The method of claim 1, wherein shuffling the cells of the storage unit comprises raising or lowering an elevation of the one or more requested parcels to allow the one or more requested parcels to be at the correct elevation to interface with a desired cell or subcell.
